(19) United States
(12) Patent Application Publication
(10) Pub. No.: US 2026/0049941 A1
(43) Pub. Date: Feb. 19, 2026

(54) METHOD FOR ELECTROCHEMILUMINESCENCE DETECTION OF HYDROQUINONE BASED ON AGGREGATION-INDUCED EMISSION CD-MOF

(71) Applicant: SUZHOU UNIVERSITY OF SCIENCE AND TECHNOLOGY, Suzhou City (CN)

(72) Inventors: Chunxian GUO, Suzhou City (CN); Huanhuan XING, Suzhou City (CN); Zihan ZHOU, Suzhou City (CN)

(21) Appl. No.: 19/237,088

(22) Filed: Jun. 13, 2025

Related U.S. Application Data
(63) Continuation of application No. PCT/CN2025/097098, filed on May 26, 2025.

(30) Foreign Application Priority Data
Aug. 19, 2024 (CN) 202411136077.1

(51) Int. Cl. G01N 21/76; C09K 11/06

(52) U.S. Cl. CPC G01N 21/76; C09K 11/06; C09K 2211/188

(57) ABSTRACT

A method for electrochemiluminescence detection of hydroquinone based on aggregation-induced emission Cd-MOF is provided, including: step 1, preparation of Cd-MOF material; step 2, mixing Cd-MOF material with co-reactant; and step 3, establishment and application of hydroquinone sensor. The organic ligand TPPE with aggregation-induced emission effect and CdCl₂ are used to prepare self-luminous Cd-based metal-organic framework Cd-MOF with rigid and directional structure through coordination.

### CROSS-REFERENCE TO RELATED APPLICATIONS

This application is a continuation of International Patent Application No. PCT/CN2025/097098, filed May 26, 2025 and claims priority of Chinese Patent Application No. 202411136077.1, filed on Aug. 19, 2024. The entire contents of International Patent Application No. PCT/CN2025/097098 and Chinese Patent Application No. 202411136077.1 are incorporated herein by reference.

### TECHNICAL FIELD

The present disclosure belongs to the technical field of equipment technology, and in particular relates to a method for electrochemiluminescence (ECL) detection of hydroquinone (HQ) based on an aggregation-induced emission cadmium-metal-organic framework (Cd-MOF).

### BACKGROUND

Electrochemiluminescence (ECL) is a process in which an electrochemically triggered reaction excites a luminophore to produce an excited state, and the return of the excited state to the ground state generates light emission. Due to its high sensitivity, excellent spatial and temporal resolution, and ultra-low background interference, ECL has become a powerful analytical tool in various fields. In addition to traditional typical ECL luminophores (such as Ru (bpy) 32+ and luminol derivatives),

Over the past two decades, ECL luminophores based on novel nanomaterials have been extensively studied, such as quantum dots (QDs), upconversion materials, metal nanoclusters, and metal-organic frameworks (MOFs). Among them, MOF-based ECL systems have attracted significant research interest due to their inherent high specific surface area, rapid mass transport, easily accessible catalytic active sites, efficient internal charge transfer (IRCT), and excellent structural and chemical tunability.

The efficient emitter based on MOFs are mainly focused on the following two cases: firstly, MOFs serving as carriers to encapsulate or enrich luminophores or to dope catalysts to enhance ECL emission; secondly, self-luminous MOFs acting as efficient emitters, constructing high-efficient ECL systems based on the antenna effect or intramolecular energy transfer, such as europium-metal-organic framework (Eu-MOF), terbium-metal-organic framework (Tb-MOF), and electroactive MOFs.

At present, the catalytic active sites of silver (Ag) are introduced into silver-based metal-organic framework (AgMOF) prepared by mixing the aggregation-induced emission luminogens (AIEgens) ligand 1,1,2,2-tetrakis (4-pyridylphenyl)ethylene (TPPE) and AgNO₃, which may catalyze the co-reactant S₂O₈²⁻ to produce more SO₄⁻ and produce stronger ECL emission. However, the catalytic active sites of Ag often exhibit poor photostability, and most developed AIEgen-derived MOFs are synthesized through time-consuming solvothermal methods, making the development process cumbersome and time-consuming.

Hydroquinone (HQ) is widely used in whitening cosmetics and industrial fields. Due to its low degradability and high toxicity, it is considered a highly hazardous environmental pollutant by the U.S. Environmental Protection Agency and the European Union. In recent decades, various analytical techniques have been applied to detect HQ, such as fluorescence, colorimetry, chemiluminescence, high-performance liquid chromatography, chromatography, and electrochemical techniques. However, these analytical techniques still suffer from inherent drawbacks, such as low sensitivity, expensive instrumentation, and complex pretreatment, which limit the simple, rapid, low-cost, and sensitive analysis of HQ. Therefore, the present disclosure proposes a method for ECL detection of HQ based on an aggregation-induced emission Cd-MOF to address the issues in the prior art.

### SUMMARY

In view of the above problems, an objective of the present disclosure is to propose a method for electrochemiluminescence (ECL) detection of hydroquinone (HQ) based on an aggregation-induced emission cadmium-metal-organic framework (Cd-MOF). The method for the ECL detection of the HQ based on the aggregation-induced emission Cd-MOF uses the organic ligand 1,1,2,2-tetrakis (4-pyridylphenyl)ethylene (TPPE) with aggregation-induced emission effect and CdCl₂ to form a rigid and directional structure through coordination, producing a self-luminous Cd-based metal-organic framework Cd-MOF within seconds, effectively restricting the intramolecular free rotation of TPPE and suppressing non-radiative relaxation, providing a rapid and simple strategy for MOF synthesis.

Simultaneously, the prepared Cd-MOF exhibits significant ECL performance. Based on this, a highly sensitive ECL sensor for HQ is constructed, offering a rapid, highly sensitive, and low-cost detection method for HQ detection.

To achieve the objective of the present disclosure, the following technical solution is adopted: a method for ECL detection of HQ based on an aggregation-induced emission Cd-MOF, including following steps:
step 1, at room temperature, mixing an organic ligand TPPE with an aggregation-induced emission effect and CdCl₂ dispersed in a mixed solution of dimethylacetamide, dimethyl sulfoxide, and isopropanol to obtain a self-luminous Cd-MOF material; after centrifugal cleaning, dispersing the material in dichloromethane (DCM) for later use;
step 2, mixing the Cd-MOF material with a co-reactant to prepare an integrated Cd-MOF material; and
step 3, based on a high-efficient electrochemiluminescence performance of the prepared integrated Cd-MOF material, establishing a HQ sensor and using the sensor to detect the HQ.

In an embodiment, in the step 1, the TPPE and the CdCl₂ are mixed in equal volumes in a centrifuge tube; the DCM is used for the centrifugal cleaning of Cd-MOF, and a cleaned product Cd-MOF material is filtered out and dispersed in the DCM.

In an embodiment, in the step 1, concentrations of the TPPE and the CdCl₂ in a mixture formed by mixing the TPPE and the CdCl₂ are both 2 millimolar (mM).

The beneficial effects of the present disclosure are as follows. The present disclosure uses the organic ligand TPPE with aggregation-induced emission effect and CdCl₂ to form a rigid and directional structure through coordination, producing a self-luminous Cd-based metal-organic framework Cd-MOF within seconds, effectively restricting the intramolecular free rotation of TPPE and suppressing non-radiative relaxation, providing a rapid and simple strategy for MOF synthesis.

Simultaneously, the prepared Cd-MOF exhibits significant ECL performance. Based on this, a highly sensitive ECL sensor for HQ is constructed, offering a rapid, highly sensitive, and low-cost detection method for HQ.

### BRIEF DESCRIPTION OF THE DRAWINGS

FIG. 1 is a flowchart of a method according to Embodiment 1 of the present disclosure.

FIG. 2 is a schematic diagram of an electrochemiluminescence (ECL) reaction mechanism of cadmium-metal-organic framework (Cd-MOF) on an electrode surface and construction of an ECL sensor for hydroquinone (HQ) “signal-off” according to Embodiment 1 of the present disclosure.

FIG. 3 is a diagram of ECL responses of the Cd-MOF to different concentrations of HQ according to Embodiment 1 of the present disclosure.

FIG. 4 is a linear relationship diagram between ECL signals and logarithm of HQ concentration according to Embodiment 1 of the present disclosure.

FIG. 5 is a histogram of selectivity of the ECL sensor for HQ constructed in Embodiment 1 of the present disclosure.

FIG. 6A is photoluminescence (PL) spectra of Cd-MOF material according to Embodiment 2 of the present disclosure.

FIG. 6B shows PL responses caused by mixing different metal ions with 1,1,2,2-tetrakis (4-pyridylphenyl)ethylene (TPPE) according to Embodiment 2 of the present disclosure.

FIG. 6C shows PL spectra of TPPE mixed with different concentrations of Cd²⁺ according to Embodiment 2 of the present disclosure.

FIG. 6D shows the PL emission spectra of Cd-MOF at different temperature according to Embodiment 2 of the present disclosure.

FIG. 7A shows scanning electron microscope (SEM) image of room-temperature Cd-MOF according to Embodiment 2 of the present disclosure.

FIG. 7B shows elemental mapping images of the room-temperature Cd-MOF according to Embodiment 2 of the present disclosure.

FIG. 7C shows SEM image of Cd-MOF at 150 degrees Celsius (° C.) according to Embodiment 2 of the present disclosure.

FIG. 7D shows X-ray diffraction (XRD) of the room-temperature Cd-MOF according to Embodiment 2 of the present disclosure.

FIG. 7E shows the three dimensional (3D) structure of the Cd-MOF material according to Embodiment 2 of the present disclosure.

FIG. 7F shows X-ray photoelectron spectroscopy (XPS) survey spectra of the room-temperature Cd-MOF and TPPE according to Embodiment 2 of the present disclosure.

FIG. 7G shows the XPS high-resolution spectrum (N1s) of the room-temperature Cd-MOF according to Embodiment 2 of the present disclosure.

FIG. 7H shows the XPS high-resolution spectrum (Cd3d) of the room-temperature Cd-MOF according to Embodiment 2 of the present disclosure.

FIG. 7I shows Fourier transform infrared spectroscopy (FT-IR) spectra of the room-temperature Cd-MOF and TPPE according to Embodiment 2 of the present disclosure.

FIG. 8 is the energy-dispersive spectrum analysis diagram of the Cd-MOF according to Embodiment 2 of the present disclosure.

FIG. 9 is the XPS high-resolution spectrum (N1s) of TPPE according to Embodiment 2 of the present disclosure.

FIG. 10 is the N₂ adsorption-desorption isotherm curve of the Cd-MOF according to Embodiment 2 of the present disclosure.

FIG. 11 is the pore size distribution diagram of the Cd-MOF according to Embodiment 2 of the present disclosure.

FIG. 12 is the thermogravimetric analysis (TGA) analysis diagram of the Cd-MOF according to Embodiment 2 of the present disclosure.

FIG. 13A shows the cyclic voltammetry (CV) diagrams of glassy carbon electrode (GCE), TPPE, and Cd-MOF in 0.1 mole per liter (M) pH 7.4 phosphate buffered saline (PBS) without S₂O₈²⁻ according to Embodiment 2 of the present disclosure.

FIG. 13B is the ECL-potential curves of GCE, TPPE, and Cd-MOF in 0.1 M pH 7.4 PBS without S₂O₈²⁻ according to Embodiment 2 of the present disclosure.

FIG. 14 is a CV diagram of Cd²⁺ in the PBS without S₂O₈²⁻ according to Embodiment 2 of the present disclosure.

FIG. 15 shows ECL-potential curves of GCE, Cd²⁺, TPPE, and Cd-MOF in 0.1 M pH 7.4 PBS containing 10 mM K₂S₂O₈ according to Embodiment 2 of the present disclosure.

FIG. 16 shows CV curves of GCE, Cd²⁺, TPPE, and Cd-MOF in 0.1 M pH 7.4 PBS containing 10 mM K₂S₂O₈ according to Embodiment 2 of the present disclosure.

FIG. 17 is the electrochemical impedance spectroscopy characterization diagrams of Cd-MOF and TPPE according to Embodiment 2 of the present disclosure.

FIG. 18A shows ECL spectra of GCE, TPPE, and Cd-MOF.

FIG. 18B shows an optimal solution pH for Cd-MOF.

FIG. 18C shows the effect of S₂O₈²⁻ concentration on ECL.

FIG. 18D shows the ECL stability test under optimal conditions.

### DETAILED DESCRIPTION OF THE EMBODIMENTS

To further understand the present disclosure, the following embodiments are provided to illustrate the present disclosure in detail. These embodiments are only for explaining the present disclosure and do not limit the scope of protection of the present disclosure.

### Embodiment 1

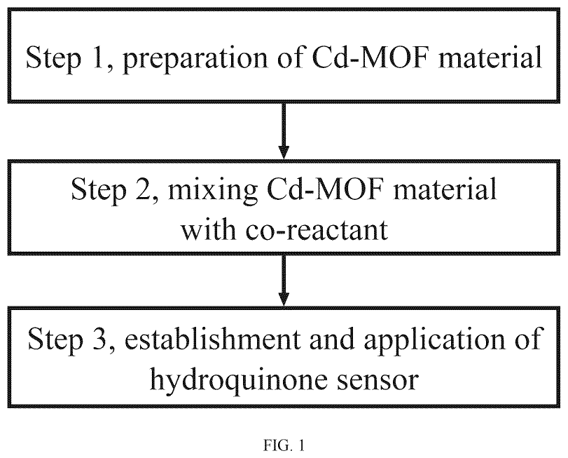

As shown in FIG. 1-FIG. 5, this embodiment provides a method for electrochemiluminescence (ECL) detection of hydroquinone (HQ) based on an aggregation-induced emission cadmium-metal-organic framework (Cd-MOF), including the following steps.

Step 1, at room temperature, the organic ligand 1,1,2,2-tetrakis (4-pyridylphenyl)ethylene (TPPE) with aggregation-induced emission effect and CdCl₂ dispersed in a mixed solution of 2 milliliter (mL) dimethylacetamide, 0.5 mL dimethyl sulfoxide, and 0.5 mL isopropanol are mixed in equal volumes in a centrifuge tube, so that the concentrations of TPPE and CdCl₂ in the mixture are both 2 millimolar (mM), and a self-luminous Cd-MOF material is obtained. Then, the dichloromethane (DCM) is used for centrifugal cleaning, the cleaned product Cd-MOF material is filtered out and dispersed in DCM for later use.

Step 2, 5 microliter (μL) of the Cd-MOF material is mixed with 2 mL of co-reactant to prepare an integrated Cd-MOF material.

Step 3, based on the high-efficient electrochemiluminescence performance of the prepared integrated Cd-MOF material, a HQ sensor based on a competitive reaction is established, and the sensor is used to detect hydroquinone.

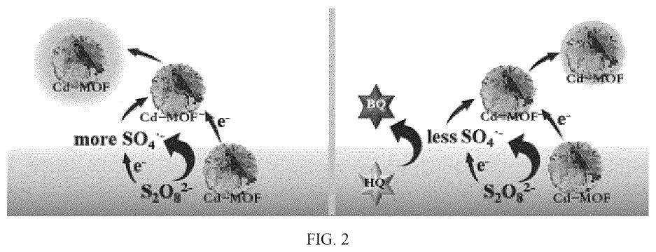

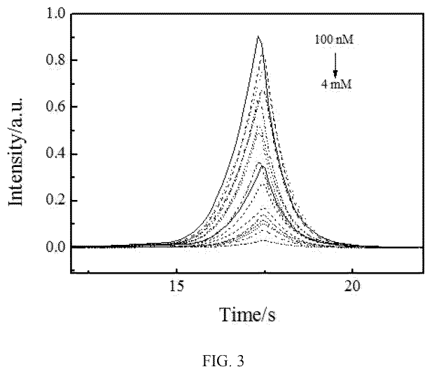

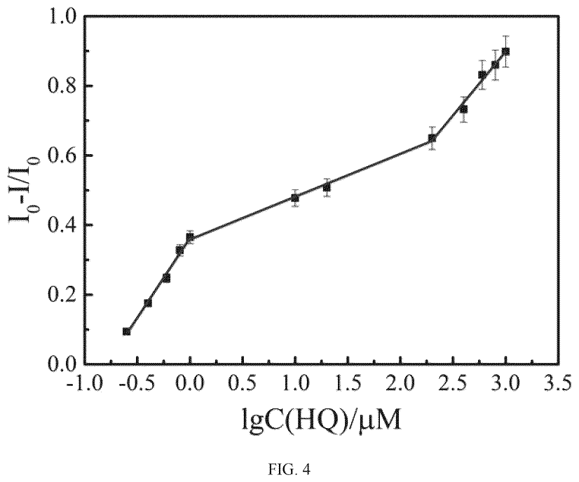

The HQ sensor adopts a quenching mechanism for detection. The quenching mechanism is based on consumption of HQ for the oxidizing intermediate SO₄^{⋅-}, as shown in FIG. 2. This intermediate may oxidize HQ to benzoquinone (BQ), resulting in a decrease in the ECL signal. As shown in FIG. 3, as the concentration of HQ increases, the ECL intensity gradually decreases, indicating that the established ECL sensor may be used to detect HQ. From FIG. 4, a good relationship between ECL intensity and HQ concentration may be obtained, with a concentration range of 200 nanomole per liter (nM) to 1 mM. The linear regression equations are I₀−I/I₀=0.362+0.457 logarithmic concentration (lgC) (0.2 micromolar (μM)-1 μM), I₀−I/I₀=0.358+0.123 lgC (1 μM-200 μM), and I₀−I/I₀=−0.199+0.365 lgC (200 μM-1000 μM). The detection limit is 80 nM (S/N=3), where I₀ represents the ECL intensity without HQ, I represents the ECL intensity at different HQ concentrations, and C represents the concentration of HQ.

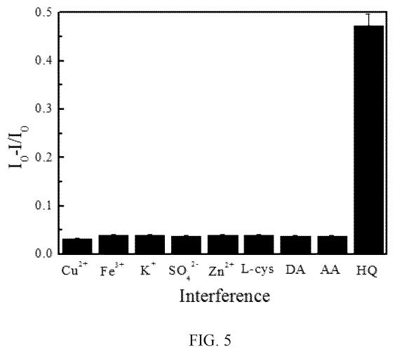

Selectivity is an important criterion for evaluating the performance of the proposed sensor. Several interfering substances are selected to verify the selectivity of the constructed Cd-MOF ECL sensor, including L-cysteine (L-Cys), dopamine (DA), ascorbic acid (AA), Cu²⁺, Fe³⁺, SO₄²⁻, K⁺, and Zn²⁺ at the concentration of 100 μM, which is 10 times higher than the concentration of HQ. As shown in FIG. 5, only the target analyte HQ may quench the ECL of the proposed system, while other interfering substances have almost no effect on the ECL signal.

In addition, satisfactory recovery analysis results are obtained by dissolving different concentrations of HQ in tap water for recovery tests. As shown in the Table 1, the recovery rates range from 96.8% to 108.9%. All the above results indicate that the ECL sensor is selective for HQ and may be used for the analysis of real samples.

TABLE 1
Recovery test of ECL sensor based on Cd-MOF

| Addition | Measurement | Recovery rate | Relative standard deviation |
|---|---|---|---|
| (μM) | (μM) | (%) | (RSD) (%) |
| 0.7 | 0.699 | 99.8 | 2.4 |
| 1.0 | 1.089 | 108.9 | 2.1 |
| 50 | 50.003 | 100.0 | 3.2 |
| 250 | 242.102 | 96.8 | 4.0 |
| 600 | 599.791 | 99.9 | 2.7 |

### Embodiment 2

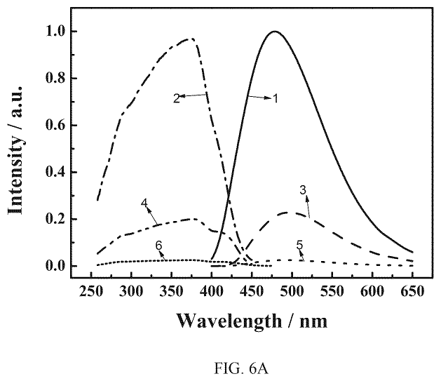

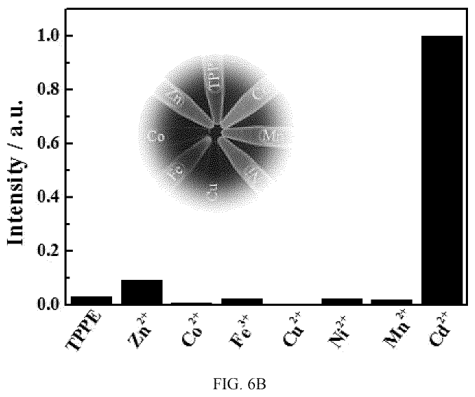

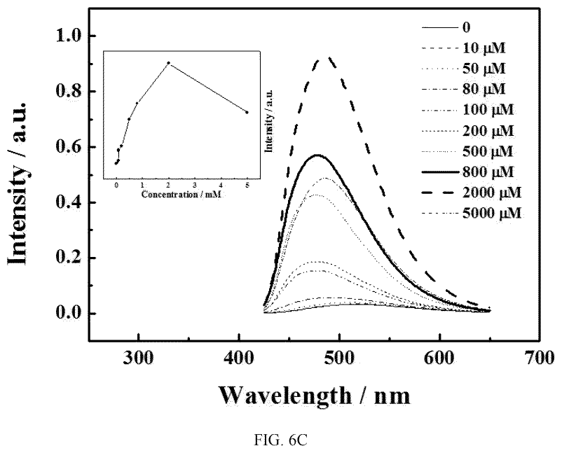

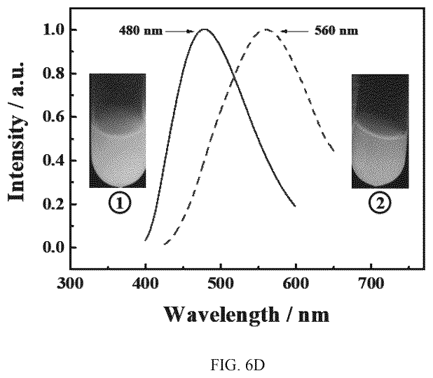

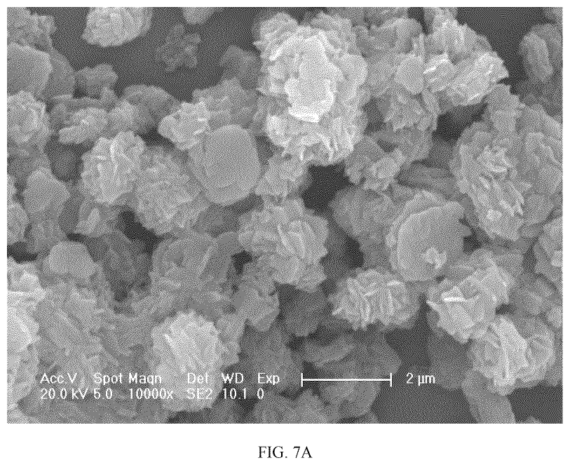

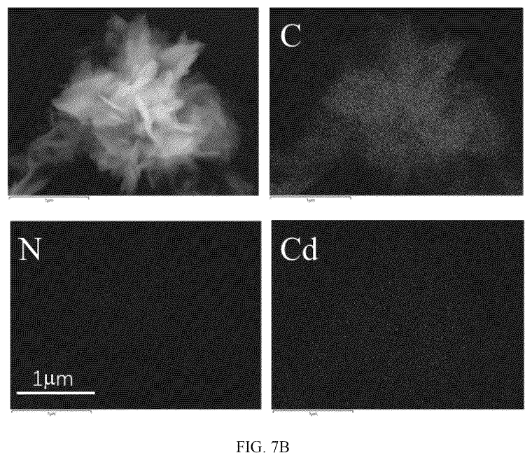

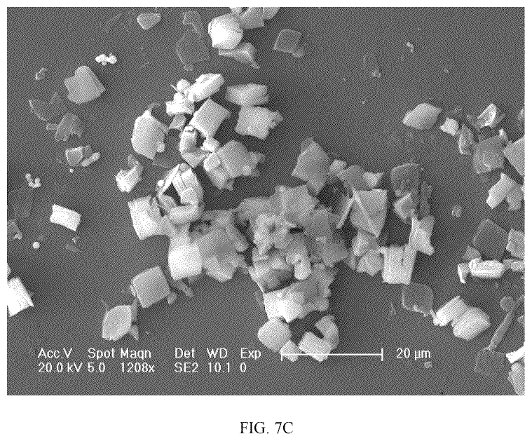

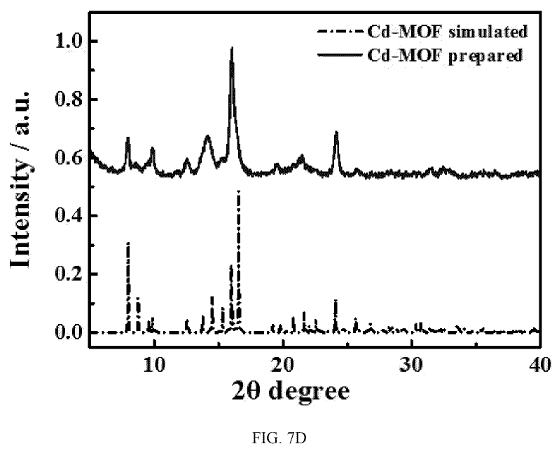

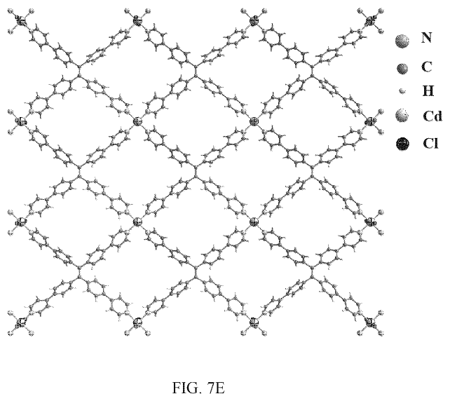

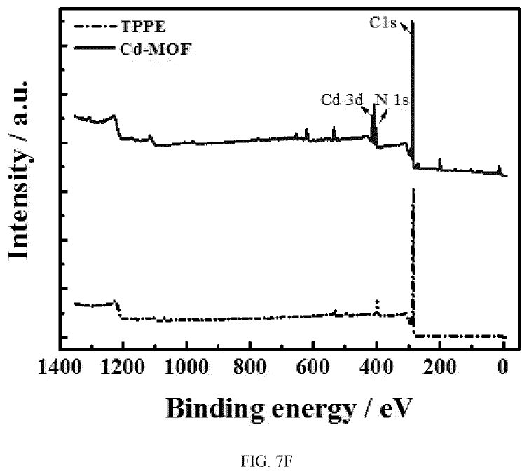

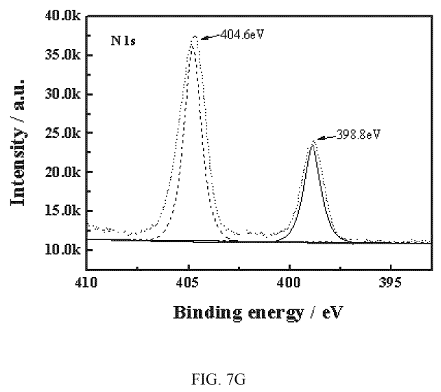

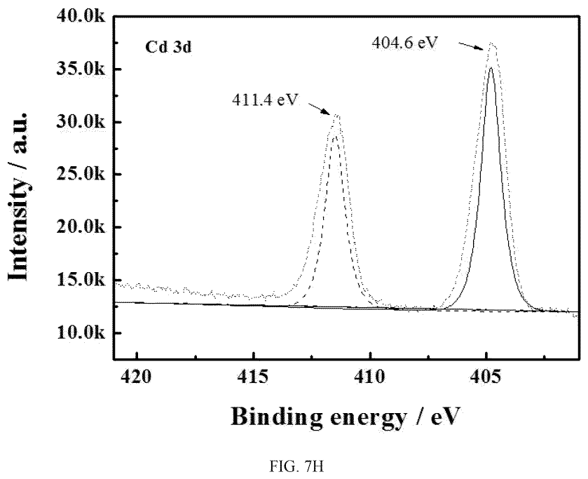

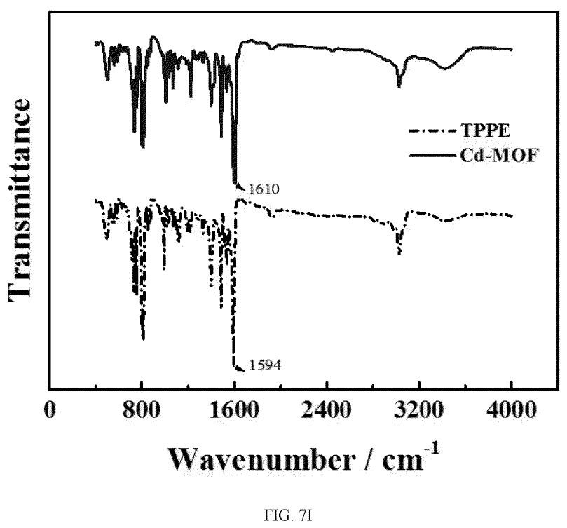

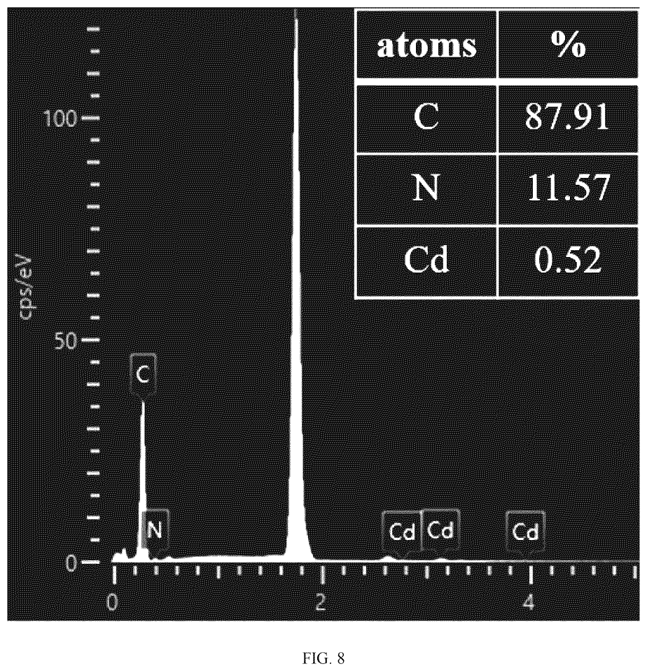

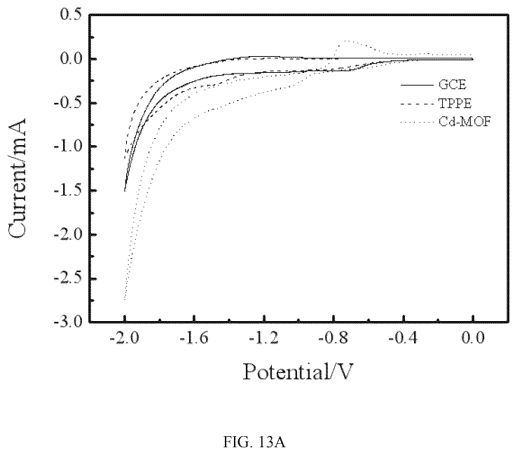

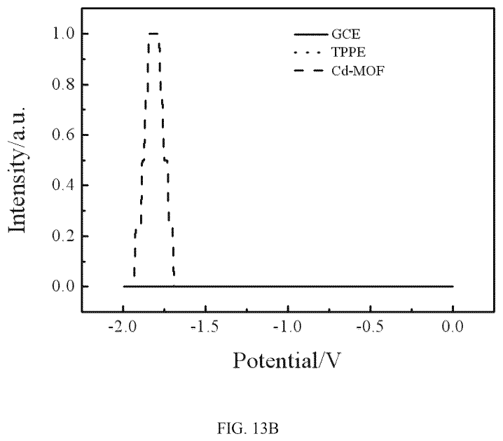

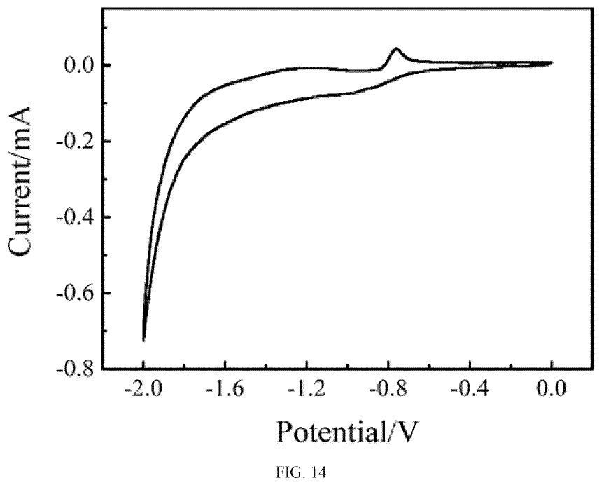

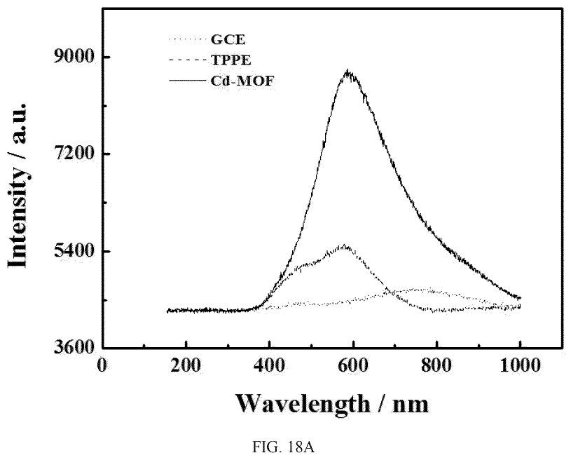

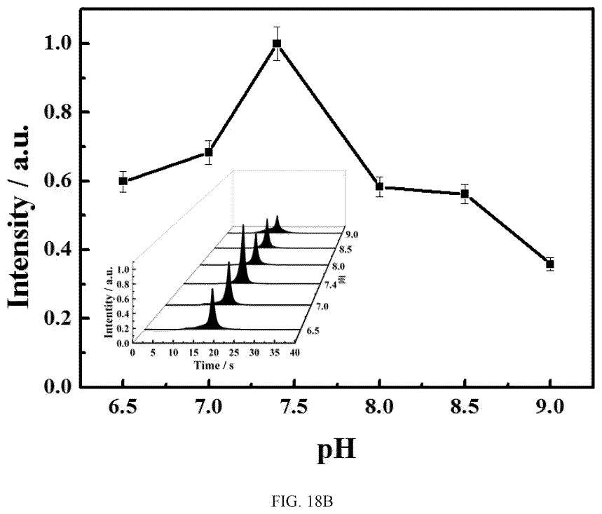

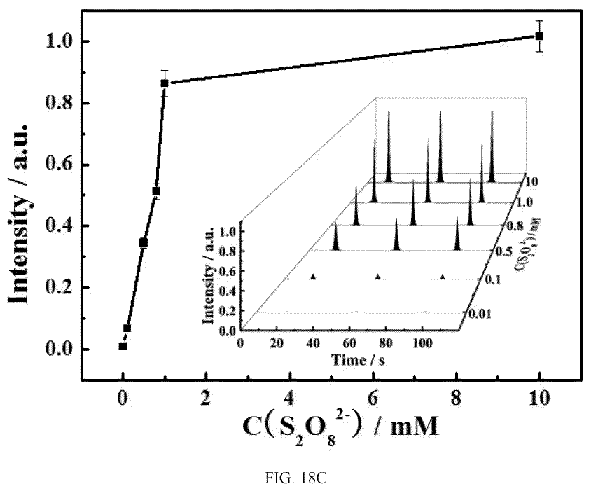

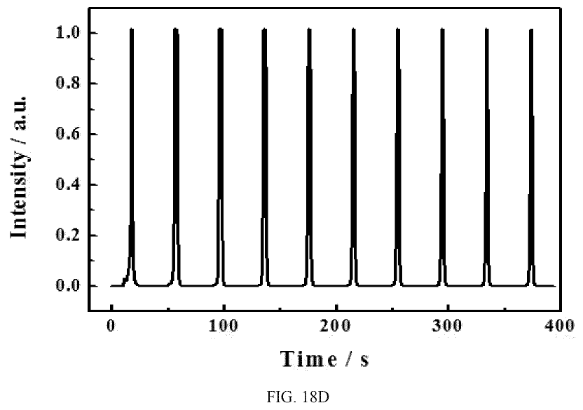

As shown in FIG. 6A-FIG. 6D, FIG. 7A-FIG. 7I, FIG. 8-FIG. 12, FIG. 13A-FIG. 13B, FIG. 14-FIG. 17, FIG. 18A-FIG. 18D, this embodiment provides the analytical properties of the self-luminous Cd-MOF material prepared in Embodiment 1, including photoluminescence (PL) property analysis, structural and compositional analysis, electrochemical and ECL performance analysis of the Cd-MOF material.

### 1. PL Property Analysis of the Cd-MOF Material

By simply mixing Cd²⁺ and TPPE at room temperature without additional organic ligands, a strongly luminescent Cd-MOF is obtained within seconds. The PL properties of the self-luminous Cd-MOF are studied, and it is found that the TPPE ligand exhibits typical AIE properties, As shown in FIG. 6A-FIG. 6D, FIG. 6A is the spectra diagram, where curve 1 represents the emission spectrum of Cd-MOF, curve 2 represents the PL excitation spectrum of Cd-MOF, curve 3 represents the emission spectrum of aggregated TPPE, curve 4 represents the PL excitation spectrum of aggregated TPPE, curve 5 represents the well dispersed TPPE emission spectrum, and curve 6 represents the well dispersed TPPE excitation spectrum. As shown in FIG. 6B shows the PL response caused by mixing different metal ions with TPPE. As shown in FIG. 6C shows the PL spectra of TPPE mixed with different concentrations of Cd²⁺. As shown in FIG. 6D shows the PL emission spectra of Cd-MOF under different temperature. As shown in the figures, TPPE exhibits good dispersibility in DCM with weak PL emission; when TPPE is dispersed in solvent H₂O, its PL intensity increases sharply, accompanied by the appearance of insoluble particles; the Cd-MOF formed by TPPE dispersed in Cd²⁺ solution, exhibits the strongest PL emission wavelength at 480 nanometer (nm) under excitation at 370 nm, showing bright blue PL visible to the naked eye under ultraviolet light irradiation, as shown in 1) in FIG. 6D. Next, common multivalent metal cations, such as Zn²⁺, Co²⁺, Fe³⁺, Cu²⁺, Ni²⁺, and Mn²⁺, are mixed with TPPE under the same experimental conditions. Compared with the PL of well-dispersed TPPE in DCM, significantly enhanced PL emission (approximately 30-fold) is observed only when 2 mM Cd²⁺ is mixed with TPPE. Unlike the emission induced by Cd²⁺, Zn²⁺ also shows enhanced PL emission (approximately 3-fold), while other metal ions mixed with TPPE does not produce significantly enhanced PL, possibly due to an alternative relaxation pathway. Furthermore, the degree of PL enhancement depends on the concentration of Cd²⁺. As the concentration of Cd²⁺ increases from 0.01 mM to 2 mM, the PL response gradually strengthens with a slight red shift, which is an inherent characteristic of AIEgen. When the Cd²⁺ concentration is further increased to 5 mM, the PL emission significantly decreases, which may be caused by the quenching effect of free metal ions after the formation of Cd-MOF.

When the reaction temperature is changed, the PL emission peak of Cd-MOF may be effectively modulated. For example, when the reaction temperature is set to 150 degrees Celsius (° C.), Cd-MOF product with bright yellow PL is obtained with a maximum emission wavelength of 560 nm, as shown in \textcircled{2} in FIG. 6D.

The above results indicate that Cd²⁺ may significantly enhance the strong PL generated by the AIEgen molecule TPPE, showing great potential in the development of ECL luminophores.

### 2. Structural and Compositional Analysis of the Cd-MOF Material

As shown in FIG. 7A-FIG. 7I, FIG. 7A shows the scanning electron microscope (SEM) image of room-temperature Cd-MOF; FIG. 7B shows the elemental mapping images of room-temperature Cd-MOF; FIG. 7C shows the SEM image of Cd-MOF at 150° C.; FIG. 7D shows the X-ray diffraction (XRD) of room-temperature Cd-MOF; FIG. 7E shows the three dimensional (3D) structure; FIG. 7F shows the X-ray photoelectron spectroscopy (XPS) survey spectra of room-temperature Cd-MOF and TPPE; FIG. 7G shows the Nls XPS high-resolution spectrum of room-temperature Cd-MOF; FIG. 7H shows the Cd3d XPS high-resolution spectrum of room-temperature Cd-MOF; and FIG. 7I shows the Fourier transform infrared spectroscopy (FT-IR) spectra of room-temperature Cd-MOF and TPPE.

To further clarify the formation process of Cd-MOF at room temperature, SEM are first used to reveal the morphological structure of Cd-MOF obtained at room temperature. Uniformly dispersed 3D flower-like Cd-MOF with a size of about 2 micrometer (μm), composed of stacked two dimensional (2D) nanosheets, is prepared. After further solvothermal reaction at 150° C., the 2D nanosheets are assembled into larger cubic-like Cd-MOF, similar to the sheet-like morphology obtained at room temperature. The elemental distribution images demonstrate the uniform distribution of C, N, and Cd elements on the surface of the flower-like Cd-MOF, consistent with the results of the energy-dispersive spectrum. The energy-dispersive spectrum analysis of Cd-MOF is shown in FIG. 8. The XRD pattern of Cd-MOF shows clear XRD diffraction peaks, consistent with the powder X-ray diffraction (PXRD) simulated from the single crystal X-ray diffraction (SCXRD) data of Co(TPPE)Cl₂·4DMA, confirming the good crystalline structure of Cd-MOF.

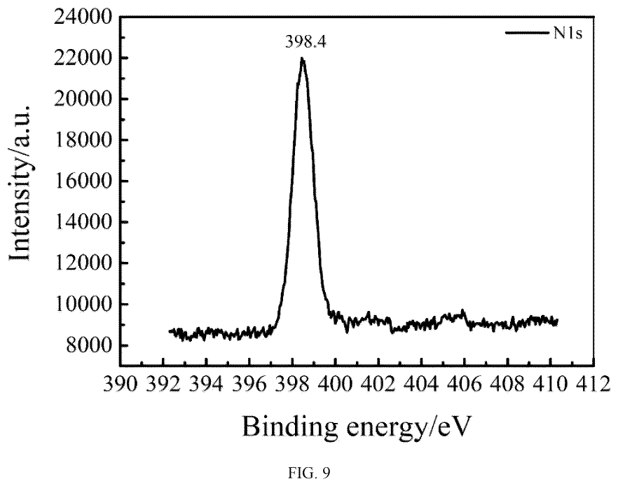

The Cd-MOF is further analyzed by XPS, FT-IR, and Brunauer-Emmett-Teller (BET) characterization. XPS reveals the elemental composition and chemical states of Cd-MOF. As shown in the XPS survey spectra of Cd-MOF and TPPE, the peaks at 284.2, 398.8, and 404.8 electron volt (eV) in the XPS survey spectra correspond to C1s, N1s, and Cd3d, respectively. In the NIs high-resolution spectrum of Cd-MOF, two peaks appear at 398.8 and 404.6 eV, belonging to pyridinic N and the overlapping peak of Cd3d at 404.6 cV. Compared with the pyridinic N in TPPE (the N1s XPS high-resolution spectrum of TPPE is shown in FIG. 9), the peak of pyridinic N in Cd-MOF significantly shifts toward higher binding energy, as shown in the Nls high-resolution spectrum in FIG. 7G. Additionally, the XPS peaks of Cd3d observed in the Cd3d high-resolution spectrum in FIG. 7H are located at 404.8 and 411.4 eV, which shift toward lower binding energy compared to the previously reported values of Cd3d at 405 and 411.9 eV, indicating the coordination effect between TPPE and Cd²⁺.

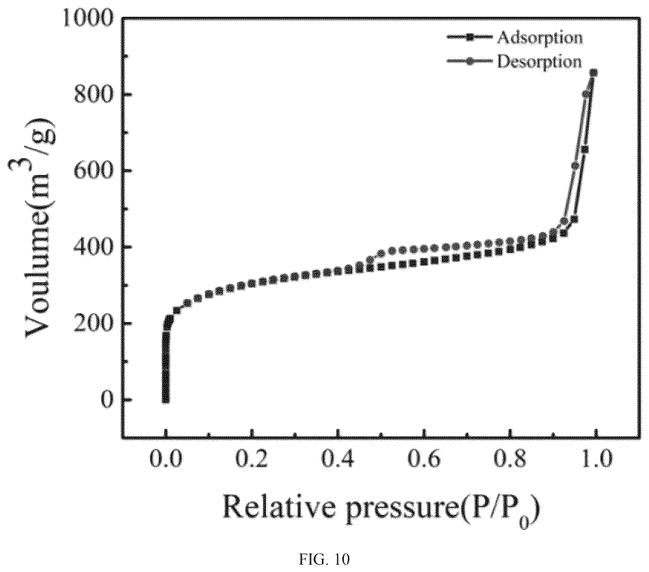

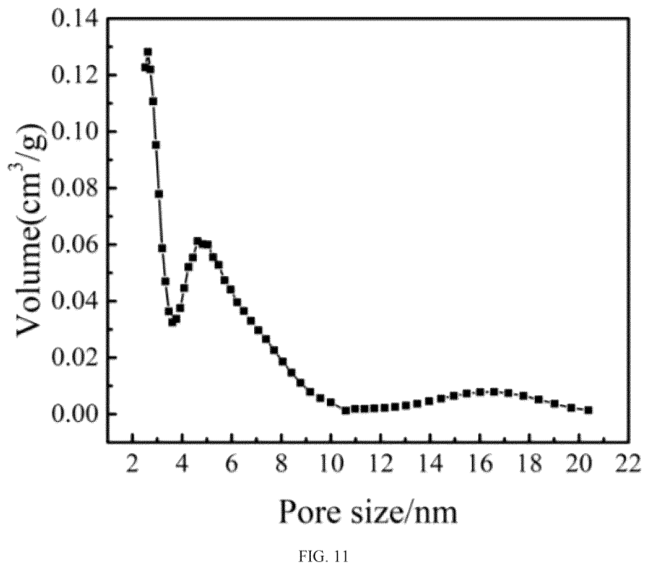

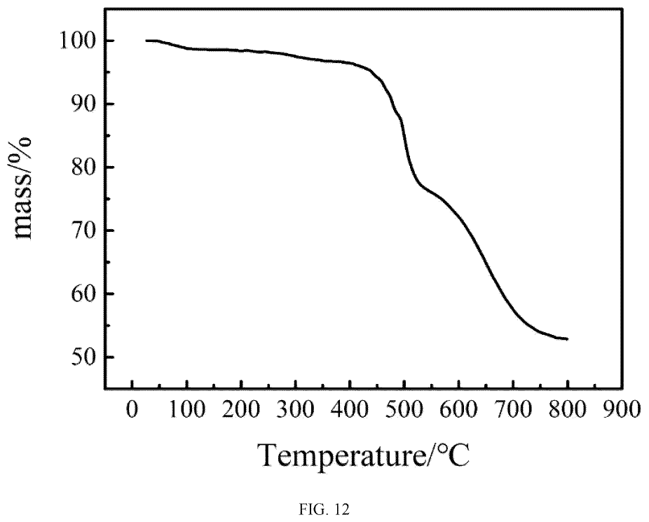

Furthermore, the FT-IR spectrum of Cd-MOF is almost identical to that of TPPE. However, after the formation of Cd-MOF, the characteristic peak of v (C═N) in TPPE (1594 cm⁻¹) shifts to a higher wavenumber (1610 cm⁻¹), further verifying the coordination effect between pyridinic N and Cd²⁺. From the N₂ adsorption-desorption isotherm curve of Cd-MOF shown in FIG. 10, the adsorption-desorption curve is calculated using the Brunauer-Emmett-Teller (BET) formula, revealing that the specific surface area of Cd-MOF is 1125 square meters per gram (m²/g). As shown in FIG. 11, the pore size of Cd-MOF is greater than 2 nm, indicating that Cd-MOF has a high specific surface area that may expose more reactive active sites and a porous structure that may accelerate mass transfer. The TGA in FIG. 12 shows no significant weight loss in the first stage from 200° C. to 400° C., corresponding to the removal of adsorbed solvent molecules DCM in the framework. However, a significant second weight loss occurs at higher temperatures of 425-500° C. due to the pyrolysis of TPPE in the framework. Therefore, the pyridine molecular structure exhibits good thermal stability, and the formed Cd-MOF material also possesses strong stability.

### 3. Electrochemical and ECL Performance Analysis of the Cd-MOF Material

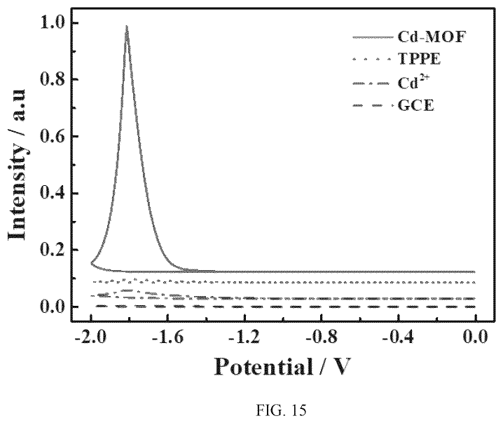

The cyclic voltammetry (CV) and ECL tests of TPPE and Cd-MOF are conducted in 0.1 M PBS buffer (pH=7.4) with and without the co-reactant S₂O₈²⁻, respectively. As shown in the CV curves (FIG. 13A) of GCE, TPPE, and Cd-MOF in 0.1 M pH 7.4 PBS without S₂O₈²⁻, when S₂O₈²⁻ is absent in the solution, GCE does not exhibit significant redox behavior, and TPPE shows a weak reduction peak at −1.5 V. Meanwhile, Cd-MOF displays a significant reduction peak at −1.0 voltage (V) and an oxidation peak at −0.72 V, similar to the weak reduction peak at −1.0 V and the significant oxidation peak at −0.76 V of Cd²⁺ under the same conditions, as shown in FIG. 14. The ECL signal results are shown in the ECL-potential curves FIG. 13B of GCE, TPPE, and Cd-MOF in 0.1 M pH 7.4 PBS without S₂O₈²⁻, only Cd-MOF exhibits a weak ECL signal. After adding S₂O₈²⁻ to the solution, as shown in FIG. 15, TPPE also shows a weak ECL signal, while the ECL signal of Cd-MOF significantly enhances, which may be attributed to the limited intramolecular free rotation and reduced non-radiative relaxation in the rigid MOF framework.

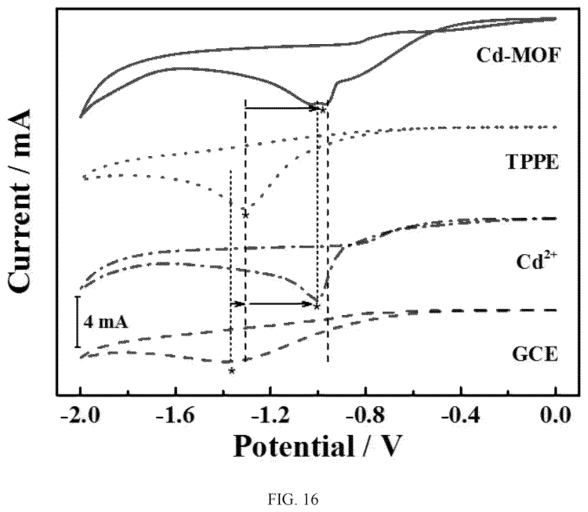

To further study the ECL enhancement mechanism, CV curves of GCE, TPPE, and Cd-MOF in buffer solution containing S₂O₈²⁻ are collected, as shown in FIG. 16. The reduction potential of S₂O₈²⁻ on GCE is-1.4 V, which represents the reduction of S₂O₈²⁻ to SO₄^{⋅-}. However, Cd-MOF exhibits two distinct reduction peaks at −0.87 V and −1.0 V. The peak at −0.87 V is the reduction peak of Cd-MOF caused by the introduction of Cd²⁺, while the peak at −1.0 V belongs to the electrochemical reduction of S₂O₈²⁻. Compared to GCE, the positive shift of the reduction peak of S₂O₈²⁻ and the increase of reduction current indicate the excellent catalytic effect of Cd-MOF on S₂O₈²⁻. Additionally, the control experiment of Cd²⁺ in buffer solution containing S₂O₈²⁻ further confirms that Cd²⁺ in Cd-MOF indeed acts as a catalytic active center. As shown in FIG. 16, the reduction potential of S₂O₈²⁻ shifts positively to −1.0 V at the Cd²⁺-modified electrode, the current increases sharply, and the ECL also enhances approximately six-fold, as shown in FIG. 15.

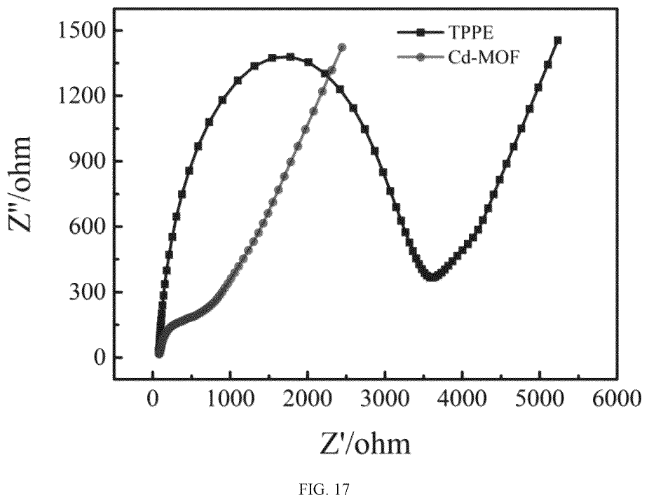

Based on the above results, it may be inferred that the ECL enhancement is due to the synergistic catalytical effect between the metal node and the AIE ligands. (I) The rigidity and directionality of the Cd-MOF framework restrict the intramolecular rotation of TPPE and suppress non-radiative relaxation. (II) The stable coordination between Cd²⁺ and TPPE endows the flower-like Cd-MOF to carry a large amount of TPPE. (III) The introduced Cd²⁺ in Cd-MOF plays an important role in catalysis of the reduction of S₂O₈²⁻. (IV) The abundant porous structure (specific surface area (SBET)=1125 m²/g) and lower interfacial electron transfer impedance compared to individual TPPE, as shown in FIG. 17, enable more TPPE ligands in the framework to be electrochemically activated.

As shown in FIG. 18A-FIG. 18D, where FIG. 18A shows the ECL spectra of GCE, TPPE, and Cd-MOF, FIG. 18B shows the optimal solution pH for Cd-MOF, FIG. 18C shows the effect of S₂O₈²⁻ concentration on ECL, FIG. 18D shows the ECL stability test under optimal conditions.

To further confirm the ECL luminophore, the ECL spectra of GCE, TPPE, and Cd-MOF are collected. As shown in FIG. 18A, GCE exhibits weak ECL emission at 773 nm, which originates from the ECL emission of the co-reactant S₂O₈²⁻. The ECL spectrum of TPPE displays an ECL emission peak at 580 nm and a weak shoulder ECL peak at 480 nm. The ECL emission at 480 nm matches its PL, indicating that this wavelength is controlled by the bandgap emission of the highest occupied molecular orbital-lowest unoccupied molecular orbital (HOMO-LUMO) energy gap. The emission at 580 nm indicates that the ECL reaction pathway involves a smaller energy gap, depending on the aggregation degree or surface state of TPPE. Similar to the ECL spectrum obtained from TPPE, the maximum ECL emission of Cd-MOF also exhibits a red shift, further indicating that the ECL emission related to the surface state dominates in Cd-MOF, due to its better aggregation degree compared to TPPE.

Notably, the ECL spectrum of Cd-MOF covers a wide range from 350 nm to 800 nm, which is beneficial for sensitive analysis without considering the photomultiplier tube (PMT) response. Based on the above discussion, the process of Cd-MOF participating in the ECL reaction on the electrode surface may be described as follows. (I) Firstly, Cd-MOF is reduced to Cd-MOF⁻. (II) Cd, as the active site in Cd-MOF, catalyzes the reduction of S₂O₈²⁻ to produce abundant SO₄^{⋅-}. (III) Due to the electron transfer between SO₄^{⋅-} and the deep surface traps of Cd-MOF, radiative recombination of electrons and holes occurs on the surface of Cd-MOF, producing the excited Cd-MOF*, which returns to the ground state and emits efficient ECL signal.

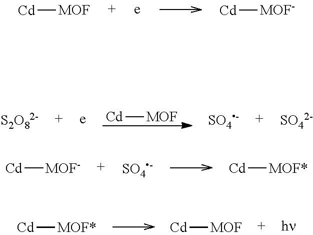

In addition, to obtain the optimal ECL signal, experimental conditions such as pH and S₂O₈²⁻ concentration in the system are studied. As shown in FIG. 18B, the ECL intensity of Cd-MOF is relatively weak in acidic media and increases with increasing pH, due to the competitive electrochemical reduction reaction of proton under negative potentials in acidic media, hindering the reduction of Cd-MOF. When the pH exceeds 7.4, the ECL signal further weakens, which is due to the scavenging effect of OH on the strong oxidizing intermediate SO₄^{⋅-} in alkaline medium, leading to the decrease of ECL. Simultaneously, the effect of the increased concentration of S₂O₈²⁻ from 0.01 mM to 10 mM on ECL is studied, as shown in FIG. 18C. As the dosage of S₂O₈²⁻ increases, the ECL intensity increases because more S₂O₈²⁻ participates in the ECL electrochemical reaction to generate abundant oxidizing intermediates SO₄^{⋅-}. Therefore, buffer solution with pH 7.4 and 10 mM S₂O₈²⁻ is selected as the optimal experimental parameter. Under optimal conditions, the ECL intensity of Cd-MOF does not change significantly after ten consecutive scanning cycles, as shown in FIG. 18D, verifying the high stability of the proposed Cd-MOF ECL system.

The above experiments describe the basic principles, main features, and advantages of the present disclosure. Those skilled in the art should understand that the present disclosure is not limited to the above embodiments. The embodiments and descriptions are only for illustrating the principles of the present disclosure. Without departing from the spirit and scope of the present disclosure, various changes and improvements may be made, all of which fall within the scope of the present disclosure as defined by the appended claims and their equivalents.

What is claimed is:

1. A method for electrochemiluminescence detection of hydroquinone based on an aggregation-induced emission Cd-MOF, comprising following steps:
step 1, at room temperature, mixing an organic ligand 1,1,2,2-tetrakis (4-pyridylphenyl)ethylene (TPPE) with an aggregation-induced emission effect and CdCl₂ dispersed in a mixed solution of dimethylacetamide, dimethyl sulfoxide, and isopropanol to obtain a self-luminous Cd-MOF material; and then, after centrifugal cleaning, dispersing in dichloromethane for later use,
wherein concentrations of the organic ligand TPPE and the CdCl₂ in a mixture formed by mixing the organic ligand TPPE and the CdCl₂ are both 2 mM;
step 2, mixing the aggregation-induced emission Cd-MOF material with a co-reactant to prepare an integrated Cd-MOF material; and
step 3, based on a high-efficient electrochemiluminescence performance of the prepared integrated Cd-MOF material, establishing a hydroquinone sensor and using the hydroquinone sensor to detect the hydroquinone.

2. The method for the electrochemiluminescence detection of the hydroquinone based on the aggregation-induced emission Cd-MOF according to claim 1, wherein in the step 1, the TPPE and the CdCl₂ are mixed in equal volumes in a centrifuge tube; when cleaning the Cd-MOF material, the dichloromethane is used for the centrifugal cleaning, and a cleaned product Cd-MOF material is filtered out and dispersed in the dichloromethane.
